(19) United States
(12) Patent Application Publication
(10) Pub. No.: US 2010/0088619 A1
(43) Pub. Date: Apr. 8, 2010

(54) INTERACTIVE VISUALISATION DESIGN TIME

(76) Inventors: Ralf Rath, Viernheim (DE); Alexander Breisch, Worms (DE); Uwe Sodan, Heidelberg (DE); Benjamin Spieler, Mannheim (DE)

Correspondence Address: SAP AG, 3410 HILLVIEW AVENUE, PALO ALTO, CA, 94304, US

(21) Appl. No.: 12/243,979

(22) Filed: Oct. 2, 2008

(51) Int. Cl. G06F 3/00

(52) U.S. Cl. 715/764

(57) ABSTRACT

What is described is a method and system for development of interactive user interfaces. The interfaces provide visualization environment and the opportunity for creating visual applications with minimal coding. A scene is selected from a scene catalogue and a visualization object is selected and displayed on the scene. A data source is selected from backend data. A parameter from the content of the data source is connected to a property of the visualization object to create a script to modify the property. The script is customized and the processed visualization object is displayed on a GUI.

### FIELD OF THE INVENTION

The present invention relates to the development of interactive visual user interfaces. More precisely, the invention relates to development of interactive visualization environment for business scenarios.

### BACKGROUND OF THE INVENTION

User interface design is a design with the focus on the user's experience and interaction. The goal of the user interface design is to make the user's interaction as simple and efficient as possible in terms of accomplishing user goals. Good user interface design kepps the user focused on the task at hand, and avoids drawing attention to the interface itself. In order to create a system that is both usable and easy to adapt, the design process of an interface balances the meaning of its visual elements that conform the mental model of operation and the functionality from a technical engineering perspective.

Generally user interfaces are built with controls and code that fills the controls with data and receive user events or input. Prior technology has fixed controls, that is, a button will fire an event if the user clicks it. This narrows the prior technology to purely visual tools. A fully interactive visual environment will, in contrast, be more flexible, giving the opportunity for adjustment in any time by switching from run time to design time and calling and interacting with the backend data.

### SUMMARY OF THE INVENTION

A computer implemented method and a system for development of interactive visualization environment for a business scenario are described. In one embodiment of the invention, the method includes selecting a scene from a scene catalogue and a visualization object from a visualization object catalogue. The method also includes displaying the visualization object on the scene and selecting a data source to connect the visualization object to a backend system. The method includes connecting a parameter from the content of the chosen data source to a property of the visualization object and customizing the property to adapt the visualization object to the business scenario. The method also includes displaying the visualization object on the scene on a graphical user interface (GUI).

In one embodiment of the invention, the system includes a scene catalog for choosing a scene to serve as a background, a visualization object catalogue to provide a visualization object to be displayed on the scene, and a backend data for selecting a data source to be used. The system also includes a visualization object environment module to use the content of the data source to create a connection between a parameter from the data source and a property of the visualization object. The system also includes a display the show the visualization object on the scene.

### BRIEF DESCRIPTION OF THE DRAWINGS

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

FIG. 1 is a flow diagram of an embodiment for creating an interactive visualization environment of a business scenario.

FIG. 2a is a block diagram of an embodiment of a system for creating an interactive visualization environment of a business scenario.

FIG. 2b is a block diagram of an embodiment of the mapping between parameters of data sources to properties of a visualization object.

FIG. 3 is a diagram representing exemplary architecture of a system for creating an interactive visualization environment of a business scenario.

FIG. 4 is an example screen shot of a graphical user interface (GUI) showing the creation of an interactive visualization environment of a business scenario.

FIG. 5 is an example screen shot of a GUI showing the creation of an interactive visualization environment of a business scenario.

FIG. 6 is an example screen shot of a GUI showing the creation of an interactive visualization environment of a business scenario.

FIG. 7 is an example screen shot of a GUI showing the creation of an interactive visualization environment of a business scenario.

### DETAILED DESCRIPTION

What is described is a method and system for the rapid development of interactive user interfaces. The interfaces provide visualization environment and the opportunity for creating visual applications with minimal coding. A scene is selected from a scene catalogue and a visualization object is selected and displayed on the scene. A data source is selected from backend data. The backend data may be any remote data source of business data or business logic. A parameter from the content of the data source is connected to a property of the visualization object to create a javascript to modify the property. The javascript is customized and the processed visualization object is displayed on a graphical user interface (GUI).

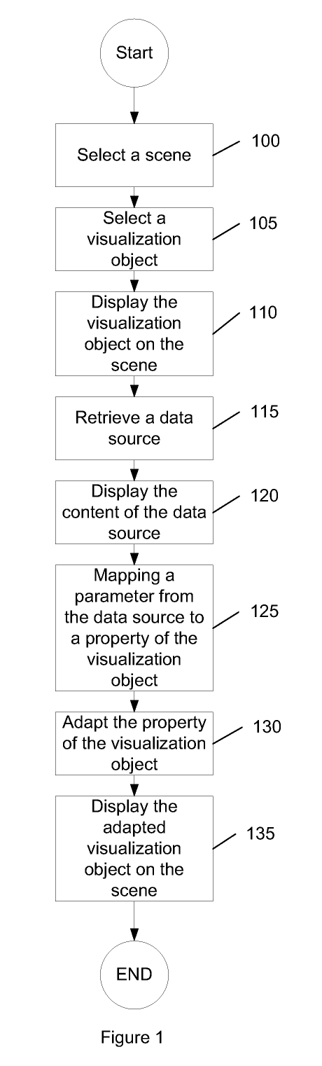

FIG. 1 is a flow diagram of an embodiment for creating an interactive visualization environment of a business scenario. At block 100, a scene is selected from a scene catalogue and displayed. The scene represents the background of the user interface being created. The scene could be two-dimensional (2D), three-dimensional (3D), geographical 2D, and geographical 3D representations. At block 105, a visualization object is selected from a visualization object catalogue. The visualization object could be 2D or 3D symbols, figures, or any kind of shape. The visualization object, for example, could be a figure or a symbol for tangible assets, a geometric figure for enclosing an area, a symbol for pointing an area, or a text box. At block 110, the visualization object and its properties are displayed. In one embodiment, the properties are displayed in an editor. The properties of the visualization object can be changed so that the visualization object fits the business scenario. Examples of the properties of the visualization object are its size, name, color, and position. At block 115, a data source is retrieved from backend data. The data source may be, for example, structured files such as xml or csv files. The access to the data source may be provided via a web service connection or any other kind of connection. The content of the data source is displayed at block 120. In one embodiment, the content is displayed such that the parameters of the content of the data source are separated as input and output data. In another embodiment, the data source update rate is configurable. Thus any change in the backend data will update the displayed content according to the defined update rate. At block 125, a parameter from the displayed content of the data source is mapped to a property of the visualization object. In one embodiment, the mapping is made by dragging and dropping the parameter onto a property of the visualization object. The mapping activity creates a script that can be used to modify the property. At block 130, the script is customized to modify the look of the linked visualization object. For example, the property “size” of the visualization object (radius, height of a geometric figure) is connected to the parameter sales_data representing the total amount of sales in a store in the following way:

size = sales_data/100000;
return size;

The sales_data parameter creates a link to the backend data and is divided by 100000, in this example, for adjusting the size of the visualization object. Thus the size of the visualization object depends on the parameter of the data source it is linked to. Another example is a simple script defining an if-then-else condition:

```
color = if(profit_data < 0)
        Red;
    else
        Green;
```

The profit_data parameter is a link to the backend data and the color of the visualization object is red in case of negative profit and green in case of positive profit.

Referring again to FIG. 1, at block 135, the customized visualization object is displayed on the scene. The data to be displayed may be selected from multiple data sources or may be multiple data from a single source. The script may be used to combine the data in any of a number of ways using formulas or the like. For example, sales data from a number of sources may be averaged together and then displayed as the size of the radius of a circle on the scene. Or, sales for each month of a year from a single source may be combined, for example, by averaging the figures, and displayed as the height of a cylinder. It will be understood by those of skill in the art that any combination of data and formula may be used to represent the data on the scene. In one embodiment, if an array of values is mapped to a property of a visualization object, then this will create multiple visualization objects of the same type but varying their properties according to the values in the array. If the visualization object is supposed to be interactive according to the business scenario, than interactions to the visualization object can be defined. The interaction could be responsive to, for instance, mouse click event or a mouse over event. Examples for reciprocal actions in case of events are “open window”, “call backend transaction”, “set visualization object properties”.

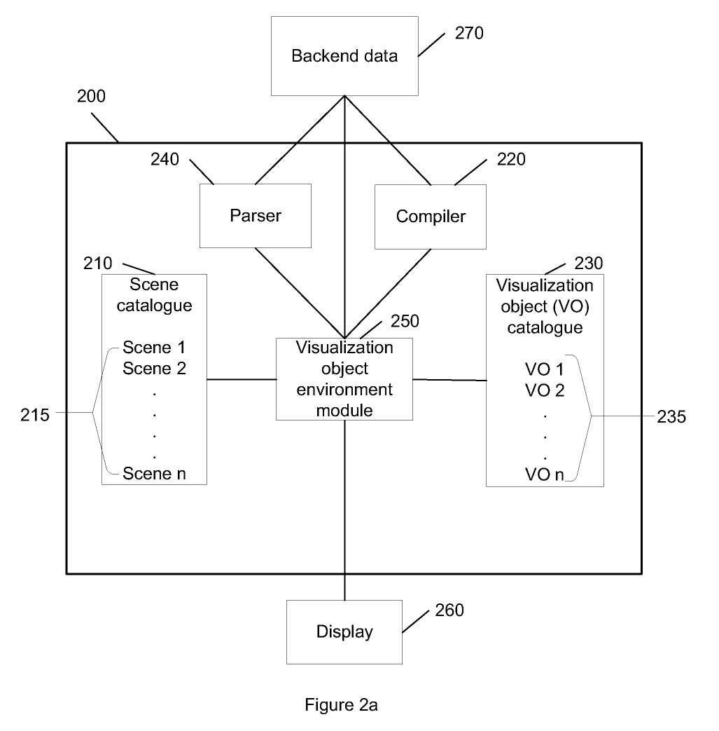

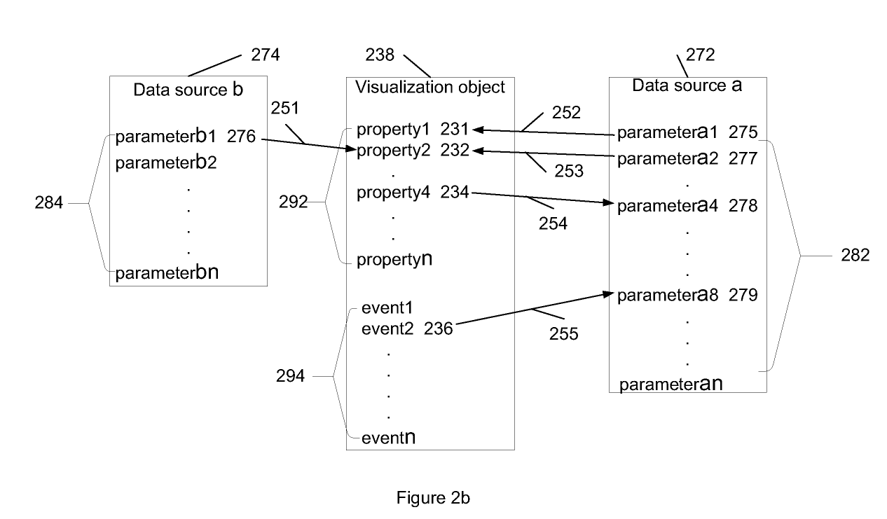

FIG. 2a is a block diagram of an embodiment of the invention for a system 200 for creating an interactive visualization environment of a business scenario. Referring to FIG. 2a, the system 200 includes a scene catalogue 210 and a visualization object catalogue 230. The scene catalogue 210 includes a number of scenes 215, used as background, representing the business scenario. Scenes 215 may be two-dimensional (2D), three-dimensional (3D), geographical 2D, and geographical 3D representations. For example, if a geographical scene is selected, a map is displayed. A selected scene from scenes 215 is rendered on a display 260. The visualization object catalogue 230 contains visualization objects 235 for use within the scene. Visualization objects 235 may be symbols representing tangible assets, 2D and 3D geometric figures representing areas and structures, text boxes, and so on. A visualization object on the scene is also rendered on the display 260. A backend data 270 provides data sources. In one embodiment, the data sources are remote data and they are linked to the system 200 by a web service connection or any other type of connection. The data sources may contain sales data, logistic data or any other kind of data. A visualization object environment module 250 maps parameters from the data sources to properties of the visualization objects. Visualization objects may have many properties. Properties may be the color, the position, the size, the width, the line width, or the radius of the visualization object. Some of the properties are constants but others may be variables and may be calculated using information contained in the backend data. Thus, the mapping from parameters of the data sources to properties of visualization objects will make these properties dependent, and a change in the data source parameter will affect the property of the visualization object and hence the representation of the visualization object on the display 260. To adapt the backend data or combine several data sources, a script language, such as Javascript, may be used. In one embodiment, the script language, used to adapt the properties of the visualization object, is compiled by a compiler 220 or interpreted by a parser 240 in order to be used by system 200.

FIG. 2b is a block diagram of an embodiment of the mapping between a visualization object and data sources. Referring to FIG. 2b, mappings from parameters of data sources 272 and 274 to properties of a visualization object 238 are shown. Data sources 272 and 274 contain parameters 282 and 284 respectively. Some of these parameters 282 and 284 are mapped to some of the properties 292 of the visualization object 238. As examples, the mappings are represented as arrows 251, 252, and 253. For example, parametera1 275 from data source 272 is mapped to property1 231 of the visualization object 238. In this simple example, the property1 231 depends on parametera1 275 only. In contrast, for example, property2 232 of the visualization object 238 depends on parameterb1 276 and parametera2 277, belonging to different data sources 274 and 272 respectively. In this example, some kind of adaptation to combine the data represented by parameterb1 276 and parametera2 277 to the single property2 232 of the visualization object 238 is required. In one embodiment, this adaptation is done by a script language, for example Javascript. Adaptation is also needed, for example, when the data from the parameters of the data sources should be scaled in order the representation of the property of the visualization object to be adequate to the business scenario and to be possible to be displayed. By means of mappings 251, 252, and 253, a change in a mapped parameter of the data bases 272 and 274 will change the property of the visualization object, to which the parameter is mapped. It is also possible to have the opposite connection. An example is the mapping 254 from the property4 234 to parametera4 278 of data source 272. Thus this mapping 254 will provide the data source 272 with an input data and by using this data, after a calculation or a quest, the data source 272 will be able to send through another mapping the output data required by the business scenario. If the visualization object 238 is interactive, then at least one of the events 294 of the visualization object 238 is defined. The mapping 255 at the bottom side show how an event2 236 may be mapped to a parametera8 279 of the data source 272 if this is necessary for the business scenario. The event could be, for instance “mouse click”, or “mouse over”.

In one embodiment of the invention, the process as described in FIG. 1 is performed by components as described in FIGS. 2a and 2b. At block 100, a scene is selected from the scene catalogue 210 and displayed on a display 260. The scene represents the background of the user interface being created. The selected scene is one of scenes 215, which are two-dimensional (2D), three-dimensional (3D), geographical 2D, and geographical 3D representations. At block 105, a visualization object 238 is selected from the visualization object catalogue 230. The visualization object 238 is one of visualization objects 235, which are 2D or 3D symbols, figures, or any kind of shape. At block 110, the visualization object 238 and its properties 292 are shown on the display 260. The properties 292 of the visualization object 238 can be changed so that the visualization object 238 is representative of the business scenario. Examples of the properties 292 of the visualization object 238 are its size, name, color, and position. At block 115, a data source is retrieved from backend data 270. The data source may be, for example, structured files such as xml or csv files. The access to the data source may be provided via a web service connection or any other kind of service connection. The parameters of the data source are displayed at block 120 on the display 260. In one embodiment, the parameters are displayed such that the parameters of the data source are separated as input and output data. In another embodiment, the data source update rate is configurable. Thus, any change in the backend data 270 will update the displayed content according to the defined update rate. At block 125, a parameter from the displayed parameters of the data source is mapped to a property of the visualization object by the visualization object environment module 250 as shown in reference to FIG. 2b above. In one embodiment, the mapping is made by dragging and dropping the parameter onto a property of the visualization object. The mapping activity creates a script that can be used to modify the property. The script is interpreted by a parser 240 or compiled by a compiler 220. The parser or the compiler calls the backend data and uses the return value for further calculation. At block 130, the script is customized to modify the look of the linked visualization object. At block 135, the customized visualization object is displayed on the scene on the display 260.

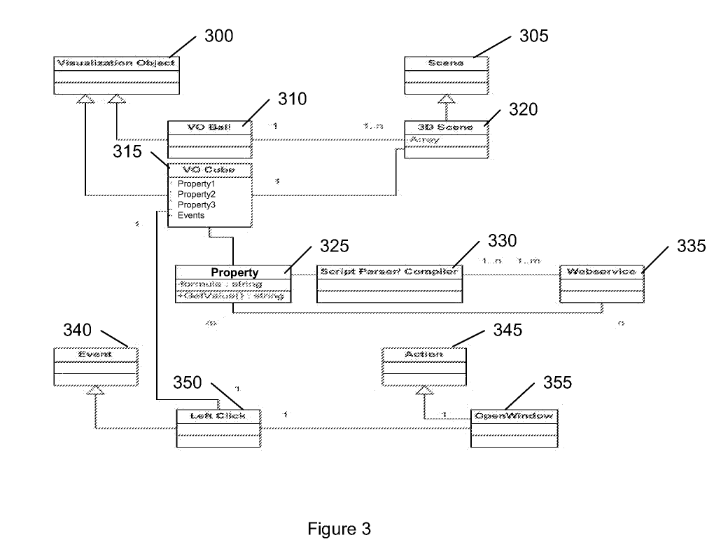

FIG. 3 is a diagram representing exemplary architecture of a system for creating an interactive visualization environment of a business scenario. The base is a catalogue of visualization objects 300. A visualization object is an abstract term for a box, a sphere, a truck, or another item suitable for the business scenario. The visualization objects are placed in a 2D or 3D scene provided by the scene catalogue 305. The scene builds the application view. The scene initializes the visualization objects and they are displayed on the scene. In the example, the visualization objects, ball 310 and cube 315, are arranged in a 3D scene 320. Each visualization object has properties, which control the representation of the object. The visualization objects draw themselves according to their properties. Some of the properties are constants, but others are variable. If a variable property 325 of the cube 315 is mapped to backend data via webservice 335, the visualization object will use the content of the backend data to determine or calculate the value of its property 325. A script is used to calculate the value of the property 325. The script is compiled or interpreted by a parser 330. The parser 330 calls the backend data via webservice 335 and uses the return value for calculation.

An exemplary script is:

```
color = if(Webservice:profit_data < 0)
    return Red;
else
    return Green;
```

If the data in the backend system changes, all affected visualization objects could be informed to update themselves. The update could be performed in accordance to a predefined or default update rate. Further, if the visualization object is interactive, then, at least one event is defined and also a related action. Referring to FIG. 3, the “left click” event 350 is applied to the visualization object cube 315. The event 350 is chosen from a set of possible events 340. The reciprocal “open window” action 355 to the event 350 is also selected from a set of possible actions 345. In one embodiment, when an event is triggered by a change in a property, the representation of the visualization object will accomplish an event and thus initiate a reciprocal action. It is also possible for any of a number of actions to be associated with one event.

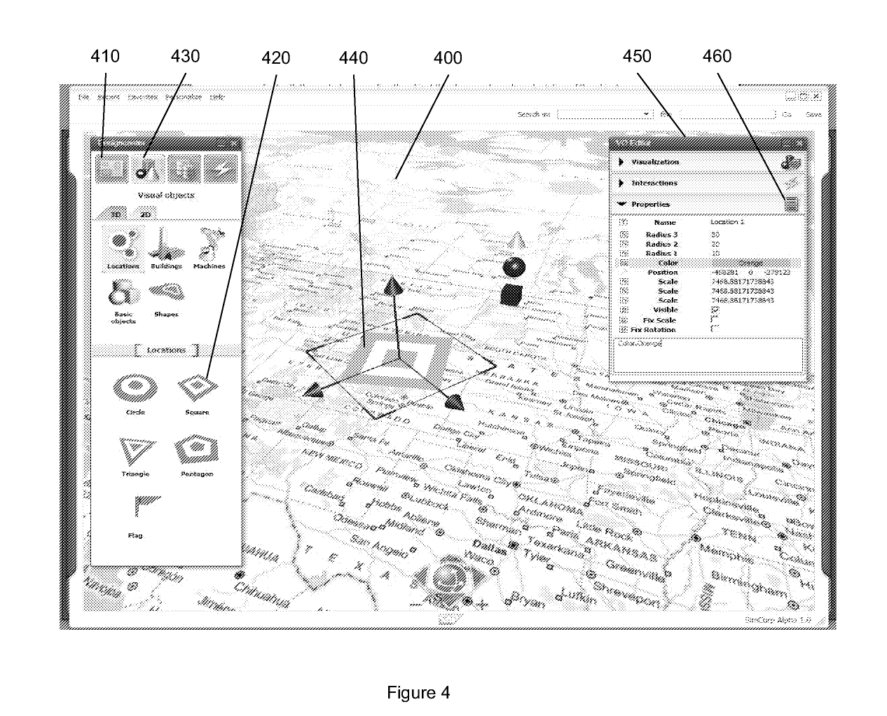

FIGS. 4, 5, 6 and 7 are example screenshots for an interactive visualization environment of a business scenario. The exemplary screenshots depict a geographic 3D scene of a country and objects representing the location and the amount of sales of the stores of a company. Referring to FIG. 4, a geographic 3D scene 400 is selected from the scene catalogue 410 and displayed via a GUI on a display. A visualization object suitable for presenting the location, such as a square enclosing an area 420, is chosen from the visualization objects catalogue 430. The visualization object 440 is placed on the scene 400 and displayed. Using the visualization object editor 450, the properties of the visualization object 440 are visible and configurable through the properties editor 460.

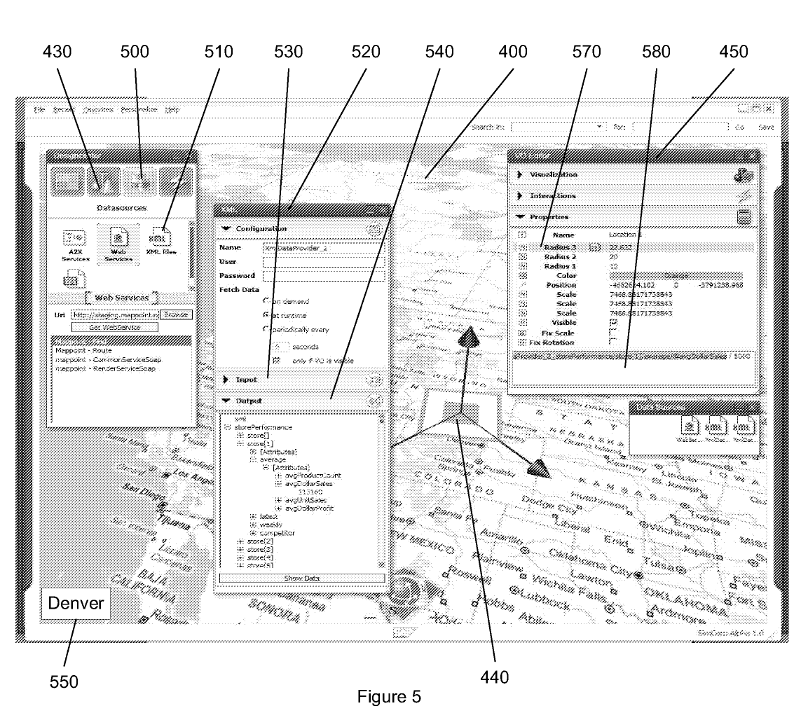

Referring to FIG. 5, by using a backend catalogue 500, a data source 510 is selected. In the example, a xml file is selected as a data source 510, consisting of the data representing the amount of sales of the stores of the company by towns. A backend editor 520 displays the content of the data source, showing the data as input and output data. The input parameters within the input data are accessible through the input editor 530 and output parameters through the output editor 540. In the example, an input parameter used is the name of the town and an output parameter used is the amount of sales. A second visualization object, a textbox 550, is selected from the visualization object catalogue 430 and placed at one corner of the scene 400. The textbox 550 is used for inputting the name of the town. A link is created between the content of the textbox 550 and the input parameter of the data source 510 (the name of the town) by dragging and dropping the content of the textbox 550 over the input parameter. Thus the name of the town written in the textbox will serve as the input parameter for the data source 510. The output parameter will contain the data for the amount of sales in the town written in the textbox 550. A second link is created by dragging and dropping the output parameter over the property “radius” 570 of the visualization object 440. Thus the property “radius” 570 is linked to the parameter representing the amount of sales for the town. A division factor is used to adjust the number, representing the amount of sales for the town to the size of the visualization object 440. This is done by a java script written in the script field 580 of the visualization object editor 450.

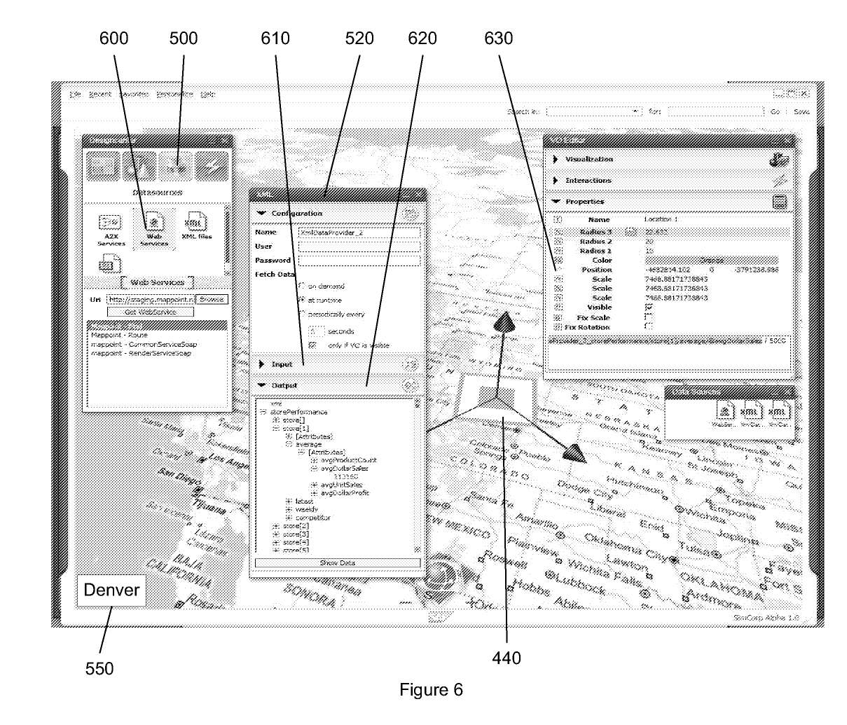

Referring to FIG. 6, a second data source 600 is selected from the backend catalogue 500. In this example, a web service is selected as the data source 600 that provides the coordinates of a town by using its name as input data. Through the backend editor 520, a xml structure of the web service is presented using the input data editor 610 for the input parameters and output data editor 620 for the output parameters. A first link is created between the name of the town from the textbox 550 and the input parameter of the web service. Thus the output will consist of the coordinates of the town written in the textbox 550. A second link is created between the output data, the coordinates of the town, and property “position” 630 of the visualization object 440. This will place the center of the visualization object 440 at a position according to the coordinates retrieved from the web service.

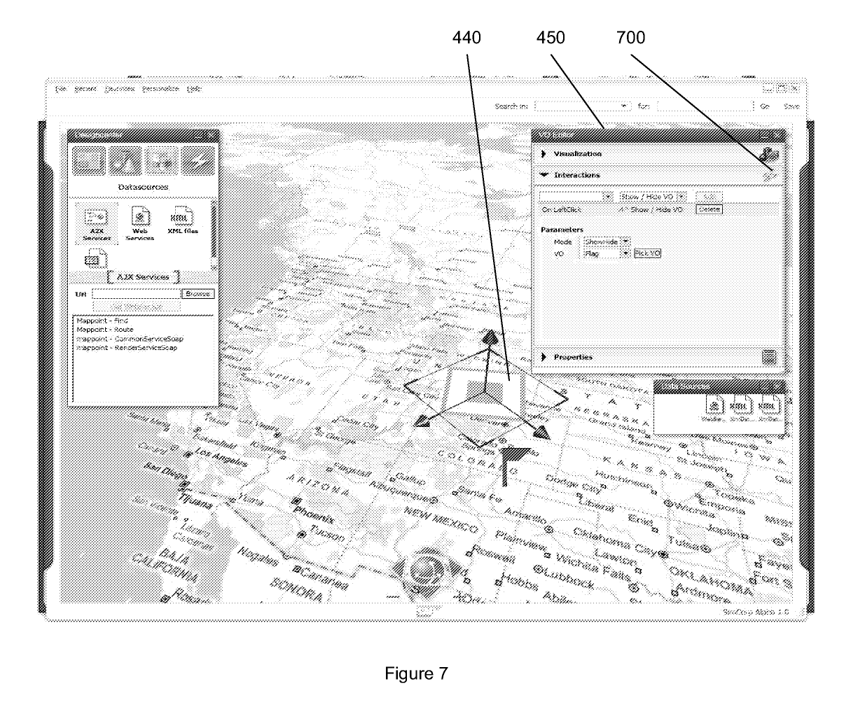

Referring to FIG. 7, an interaction to the visualization object 440 can be defined through the interaction editor 700 of the visualization object editor 450. The interaction could be for example what occurs upon a left click of the mouse. The interaction editor 700 is also used for defining an action to the chosen interaction. The action could be, for example, show or hide the visualization object 440.

This environment is saved as an application and used for visualization of the amount of sales of the stores of the company by towns by simply writing the name of a desired town in the textbox 550. The change of the name in the textbox 550 will retrieve both the location of the town and the sales data, moving the visualization object 440 to a new position according to the coordinates of the town and changing the size, in this case the radius, of the visualization object 440 according to the sales data.

The invention can be implemented as a computer program product, i.e. a computer program tangibly embodied in an information carrier, e.g., in a machine-readable storage device or in a propagated signal, for execution by, or to control the operation of, data processing apparatus, e.g. a programmable processor, a computer or multiple computers. A computer program can be written in any form or programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the invention can be performed by one or more programmable processors executing a computer program to perform functions of the invention by operating on input data and generating output.

Processors suitable for execution of a computer program include by way of example, both general and special purpose microprocessors, and any one or more processors of any kind of digital computer. Generally a processor will receive instructions and data from a read-only memory or a random access memory or both. The essential elements of a computer are a processor for executing instructions and one or more devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

To provide for interaction with a user, the invention can be implemented on a computer having a display device such as a CRT (cathode ray tube) or LCD (liquid crystal display) monitor for displaying to the user and a keyboard and a pointing device such as a mouse or trackball by which the user can provide input to the computer.

The invention has been described in terms of particular embodiments. Other embodiments are within the scope of the following claims. For example, the steps of the invention can be performed in a different order and still achieve desirable results.

The above description of illustrated embodiments of the invention, including what is described in the Abstract, is not limited to be exhaustive or to limit the invention to the precise forms disclosed. While specific embodiments of and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather the scope of the invention is to be determined entirely by the following claims.

What is claimed is:

1. A computer implemented method for creating an interactive visualization environment of a business scenario, comprising:
receiving a visualization object from a visualization object catalogue;
retrieving a data source from a backend data;
mapping a parameter from the data source to a property of the visualization object, the parameter modifying the property of the visualization object; and
displaying the mapped visualization object.

2. The method of claim 1, further comprising:
retrieving a scene from a scene catalogue, the scene representing the business scenario;
displaying the scene; and
displaying the mapped visualization object on the scene.

3. The method of claim 2, wherein the scene is retrieved from a group comprising two-dimensional (2D) scenes, three-dimensional (3D) scenes, geographical 2D scenes, and geographical 3D scenes.

4. The method of claim 1, further comprising adapting the property of the visualization object to the business scenario.

5. The method of claim 1, wherein the visualization object is selected from a group comprising symbols representing tangible assets, 2D geometric figures representing areas, 3D geometric figures representing structures, and a text box.

6. The method of claim 1, wherein retrieving a data source from backend data comprises:
retrieving a set of data sources, each of the data sources being used to connect to a specific backend data; and
identifying a data source from the set of data sources to comply with the business scenario.

7. The method of claim 1, wherein retrieving a data source from the backend data further comprises retrieving the data source via a web service.

8. The method of claim 1, wherein mapping a parameter from the data source to a property of the visualization object comprises:
retrieving a set of data from the backend system;
identifying a parameter from the set of data to modify the property of the visualization object; and
associating the identified parameter with the property.

9. The method of claim 8, further comprising defining a rate for the update of the data source represented by the identified parameter.

10. The method of claim 4, wherein adapting the property of the visualization object comprises:
creating a script to perform business logic required by the scenario; and
modifying the script.

11. The method of claim 1 further comprising:
defining an interaction for the visualization object, wherein the interaction is activated responsive to an event.

12. The method of claim 11 further comprising:
defining an action for the interaction of the visualization object, wherein the actions are selected from a group comprising an “open window” action, a “call backend transaction” action, and a “set visualization object properties” action.

13. A computerized system to create an interactive visualization environment for a business scenario comprising:
a visualization object;
at least one backend data source; and
a visualization object environment module to map at least one parameter of the at least one backend data source to at least one property of the visualization object.

14. The system of claim 13, further comprising a scene to represent the business scenario.

15. The system of claim 14, further comprising a display to render the scene and the visualization object on the scene.

16. The system of claim 14, wherein the scene is selected from a group comprising two-dimensional (2D) scenes, three-dimensional (3D) scenes, geographical 2D scenes, and geographical 3D scenes.

17. The system of claim 13, wherein the visualization object is selected from a group comprising symbols representing tangible assets, 2D geometric figures representing areas, a 3D geometric figures representing structures, and a text box.

18. The system of claim 17, wherein the group is maintained in a visualization object catalogue.

19. The system of claim 13, further comprising a parser to generate and interpret a script to adapt the at least one property of the visualization object.

20. The system of claim 13, further comprising a compiler to adapt the at least one property of the visualization object.

21. The system of claim 13, wherein the backend data source is maintained within a backend system.

22. A computer program product, tangibly stored on a machine readable medium for creating an interactive visualization environment of a business scenario, the product comprising instructions operable to cause a processor to
receive a visualization object from a visualization object catalogue;
retrieve a data source from a backend data;
map a parameter from the data source to a property of the visualization object, the parameter to modify the property of the visualization object; and
display the mapped visualization object.

23. The product of claim 22, further comprising instructions to:
retrieve a scene from a scene catalogue, the scene representing the business scenario;
display the scene; and
display the mapped visualization object on the scene.

24. The product of claim 23, wherein the scene is retrieved from a group comprising two-dimensional (2D) scenes, three-dimensional (3D) scenes, geographical 2D scenes, and geographical 3D scenes.

25. The product of claim 22, further comprising instructions to adapt the property of the visualization object to the business scenario.

26. The product of claim 22, wherein the visualization object is selected from a group comprising symbols representing tangible assets, 2D geometric figures representing areas, 3D geometric figures representing structures, and a text box.

27. The product of claim 22, wherein the instructions to retrieve a data source from backend data further comprise instructions to:
retrieve a set of data sources, each of the data sources being used to connect to a specific backend data; and
identify a data source from the set of data sources to comply with the business scenario.

28. The product of claim 22, wherein the instructions to retrieve a data source from backend data further comprises instructions to retrieve the data source from a web service.

29. The product of claim 22, wherein the instructions to map a parameter from the data source to a property of the visualization object further comprise instructions to:
retrieve a set of data from the backend system;
identify a parameter from the set of data to modify the property of the visualization object; and
associate the identified parameter with the property.

30. The product of claim 29, further comprising instructions to define a rate for the update of the content of the data source represented by the identified parameter.

31. The product of claim 25, wherein the instructions to adapt the property of the visualization object further comprise instructions to:
create a script to perform business logic required by the business scenario; and
modify the script.

32. The product of claim 22, further comprising instructions to:
define an interaction for the visualization object, wherein the interaction is activated responsive to an event.

33. The product of claim 32, further comprising instructions to define an action for the interaction of the visualization object, wherein actions include an “open window” action, a “call backend transaction” action, and a “set visualization object properties” action.
